(19) United States
(12) Patent Application Publication
(10) Pub. No.: US 2025/0026670 A1
(43) Pub. Date: Jan. 23, 2025

(54) PLASMA ELECTROEROSION REACTOR AND THE METHOD OF ITS USE

(71) Applicant: "ALPHA ATOM" LLC, Kyiv (UA)

(72) Inventors: Yurii ZABULONOV, Kyiv (UA); Serhii SHPYLKA, S. Yurivka (UA); Oleksandr PUHACH, Krolevets, Sumska obl. (UA); Viktor NIKOLENKO, Kyiv (UA); Igor PEER, Shefayim (IL); Igor TSYRLINCHUK, Bat Yam (IL)

(21) Appl. No.: 18/718,260

(22) PCT Filed: Nov. 21, 2022
(86) PCT No.: PCT/IB2022/061212

§ 371 Date: Jun. 10, 2024

(30) Foreign Application Priority Data
Dec. 9, 2021 (UA) A202107058

(51) Int. Cl. C02F 1/46; C02F 101/00; G21F 9/10

(52) U.S. Cl. CPC C02F 1/4608; G21F 9/10; C02F 2101/006

(57) ABSTRACT

The proposed invention relates to the field of liquid industrial waste treatment, in particular to the plasma electroerosion reactor for comprehensive treatment of industrial effluents and rainwater, as well as process water of nuclear power plants, for the purpose of their deactivation and purification, in particular for removing radionuclides of cesium-137 (¹³⁷Cs), strontium-90 (⁹⁰Sr), americium (²⁴¹Am), cobalt-60 (⁶⁰Co), heavy metals such as chromium (Cr), copper (Cu), zinc (Zn), nickel (Ni), tin (Sn), lead (Pb), cadmium (Cd), and to the method of its use, including for treating liquid waste of nuclear power plants (NPP).

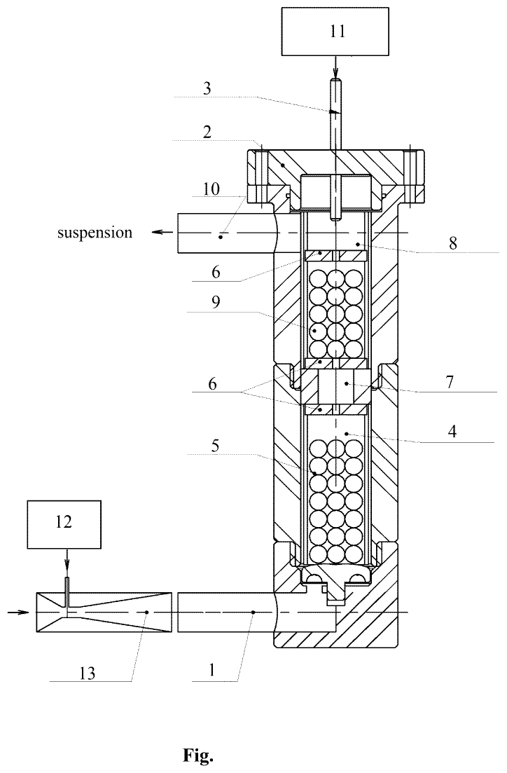

The proposed invention relates to the field of liquid industrial waste treatment, in particular to the plasma electroerosion reactor for comprehensive treatment of industrial effluents and rainwater, as well as process water of nuclear power plants, for the purpose of their deactivation and purification, in particular for removing radionuclides of cesium-137 (¹³⁷Cs), strontium-90 (⁹⁰Sr), americium (²⁴¹Am), cobalt-60 (⁶⁰Co), heavy metals such as chromium (Cr), copper (Cu), zinc (Zn), nickel (Ni), tin (Sn), lead (Pb), cadmium (Cd), and to the method of its use, including for treating liquid waste of nuclear power plants (NPP).

Persons skilled in art know that one of the methods of deactivation and treatment of contaminated liquid to remove radionuclides and heavy metals is coagulation processes using inorganic coagulants based on iron and aluminum compounds which form hydroxides of aluminum and iron in an alkaline environment able to precipitate the above-mentioned pollutants. The main disadvantage of this technology is the need to use additional reagents to create the required pH environment which complicates the application of this process and makes it more expensive.

Also the prior art [for example, see Shakhova N. B., Yurmazova T. A. A model of the physical and chemical processes that occur during the dispersion of metals by pulsed electric discharges in water and dilute salt solutions (Model fiziko-khimicheskikh protsessov, protekayushchikh pri dispergirovanii metallov impulsnymi elektricheskimi razryadami v vode i razbavlennykh rastvorakh soley)] teaches about methods of deactivation and treatment of contaminated liquid to remove radionuclides and heavy metals using coagulation processes when the coagulant is obtained during electroerosive dispersion (evaporation and condensation) of metallic aluminum or iron granules with the formation of a mixture of short-lived aluminum and iron ions, which very actively interact with cesium-137 (¹³⁷Cs), americium-241 (²⁴¹Am), strontium-90 (⁹⁰Sr), cobalt-60 (⁶⁰Co) ions during their existence, with subsequent formation of their oxides and hydroxides, coagulation of the latter and formation of complex compounds insoluble in water. For example, during the electroerosion dispersion of metallic aluminum granules in an aqueous solution of NPP liquid waste, aluminates which are insoluble salts of orthoaluminum (HAlO₂) and metaaluminum (MAl₂O₄) acids, where M is Cs, Sr, Am, Z, Zn, Pb, etc., are formed. A characteristic feature of aluminates is their isomorphism, that is the ability of chemical elements with similar chemical properties to create mixed crystals or replace each other in the composition of molecules of simple or complex substances. High selective sorption and coagulation of ionic and polyvalent complexes of aluminum oxides and hydroxides with respect to strontium (⁹⁰Sr) and cesium (¹³⁷Cs) ions is explained by the fact that strontium and cesium belong to highly active alkali and alkaline earth metals that can easily form complex compounds one with another. At the same time, it is worth noting that cesium is a metal with high dissociating ability (it splits out the Cs⁺ ion very easily). In general, an ionic form of existence is typical for cesium isotopes. Being extremely reactive, cesium hydroxide has an extremely high hygroscopicity and upon interaction with bound water in Al(OH)₃ it forms very strong aluminates that precipitate and can be easily separated from the liquid to be purified.

The destructive effect of ozone and OH′ radicals on complexones is also known from the prior art since ozone destroys almost all organic compounds very quickly. The products of the complexone destruction do not deteriorate the parameters of further processes. At the same time, the toxicity level of products formed during the oxidation of complexones with ozone and OH′ radicals is much lower than that of the original compounds. In addition, the synthesis of ozone and OH′ radicals directly during solutions processing does not require separate actions and costs for obtaining and storing a significant amount of reagents to process solutions. Thus, as a result of the complexone destruction, ions of radioactive metals pass into a form in which they are easily sorbed and coagulated. At the same time, this forms a solid phase of the corresponding hydroxides and oxides of transition metals (Fe, Ni, Cr, etc.), which are usually present in the initial solution that is subjected to purification. Radionuclides of cobalt (Co), zinc (Zn), lead (Pb), etc. are sorbed on these hydroxides and oxides. At the same time, the depth of oxidation of organic complexes significantly affects the degree of removal of these and other radionuclides.

Water treatment by removing heavy metals and radionuclides using iron hydroxides has been carried out for a long time, mainly using the ferritization method [for example, see RU2220110, UA95723]. The disadvantages of this method include its high energy consumption since it is usually carried out at a temperature above 75° C.

It is possible to increase the energy efficiency of the ferritization process by replacing the high-temperature activation by subjecting the reaction mixture to electromagnetic pulse discharges of different power at room temperature [for example, see SUI787950, SU861332, UA56454]. Methods of water treatment in the electrolyzer chamber using both constant and alternating voltage are also known [for example, see UA11271, UA2180, UA902, UA124]. The general disadvantage of the specified technologies is their relatively low efficiency as well as possible passivation and even destruction of the electrodes by organic substances present in the effluents.

A solution close to the claimed invention is reactors that use the electric discharge technology, wherein the coagulation process is carried out with the help of metal particles, in particular, aluminum, added into the reactor, which allows to increase significantly and accelerate the coagulation process, compared to the effluents treatment by electrolyzers [Zubenko A. A., Yuschishena A. N. Studying the properties of electric-discharge aluminum hydroxide (Issledovaniye svoystv elektrorazryadnogo gidroksida alyuminiya) Elektronnaya obrabotka materialov, 2001. No. 6, pp. 60-65]. The disadvantage of these methods is that it is impossible to treat complex compounds containing organic substances and radionuclides.

Another solution close to the claimed invention is the technical solution according to WO 2020180277, in which water to be purified is supplied to the reactor with metal granules placed in it. Under the influence of electric pulses applied to the electrodes, the process of electroerosion of granules takes place and, with the additional supply of an air-oxygen mixture, their particles cause coagulation of heavy metal ions. The disadvantage of this solution is the periodic nature of the process, which allows purifying of a limited amount of water. Another disadvantage of this technical solution is the use of unipolar pulses, which significantly reduces the efficiency of the reactor.

Another solution close to the claimed invention is the technical solution according to UA124651, which provides for a discharge chamber made of a dielectric material with built-in electrodes and a partition in the lower part, in which there are aluminum granules; under the influence of electric pulses, these granules interact with each other, causing the process of electroerosion with the formation of aluminum hydroxides, as well as orthoaluminic and metalloaluminic acids, which are coagulants and show high purification rates for liquid waste of nuclear power plants. The main disadvantage of the above technical solution is its low efficiency in terms of radioactive elements coagulation that usually exist in the form of compounds with organic complexes in liquid waste. In addition, liquid radioactive waste usually contains organic substances that significantly complicate the treatment process and the use of unipolar pulses leads to the passivation of the reactor's electrodes reducing its efficiency.

The closest prior art to the claimed invention is the technical solution disclosed in the utility model patent of Ukraine No. 76821, which was chosen as a prototype. In this technical solution, a reactor with electrodes embedded inside the reactor chamber is used to clean polluted water. Unipolar pulses with a duty cycle of 75-85 microseconds and a voltage amplitude of 300-800 V are applied to the electrodes. The reactor chamber is filled with water to be purified through the inlet pipe. Inside the chamber, there are spherical granules made of iron and aluminum alloys, which take up approximately 20-25% of the chamber volume and interact with each other under the pressure of water and the influence of electric pulses applied to the electrodes of the reactor, generating an electric spark at the point of contact, which causes electroerosion of granules, generating metal ions, accompanied by ozone generation, local temperature rise and cavitation, which in turn allows obtaining coagulants—iron and aluminum hydroxides, which interact with heavy metals and radioactive elements to form complexes that precipitate. In the chamber, there are upper and lower partitions that prevent the removal of granules from the working volume, whereas, in the upper part of the reactor, there is a nozzle for draining purified water.

The specified technical solution has several disadvantages, namely:
with Fe—Fe, Al—Fe, and Al—Al granules, the simultaneous use of iron and aluminum metal granules leads to a different power of a discharge reducing the electroerosion efficiency. At the same time, aluminum granules wear out faster than iron granules, which leads to a loss of the iron-aluminum mass ratio, inhomogeneity of the discharge medium, and a less efficient coagulation process;
a large concentration of coagulant causes a selective interaction of iron ions with organic matter dissolved in the water to be purified, and not with heavy metals and radioactive elements, thus reducing the purification of polluted water from radioactive elements and heavy metals;
passivation of electrodes with organic substances when using unipolar voltage pulses;
the amount of generated ozone is not enough to oxidize organic substances present in pollutants.

The aim of the claimed invention is to create a highly efficient plasma electroerosion reactor and the method of its use for treating liquid industrial waste, including particular those that contain pollutants of organic origin, to remove radioactive elements and heavy metals.

The task is solved by creating a plasma electroerosion reactor for treating liquid waste, which includes: an inlet pipe for supplying liquid waste, located in the lower part of the reactor; a discharge chamber of a cylindrical or another curvilinear shape made of dielectric material and filled with metal granules (balls) which ensures stable passage of liquid and that there are no “dead” zones. Wherein, in the lower and upper parts of the chamber, there is a dielectric grid that limits the removal of granules by liquid from the chamber; in the upper part of the reactor, there is an outlet pipe for removing the coagulated suspension; on the inner surface of the reactor, there are metal electrodes, in particular steel ones, wherein a source of rectangular pulses with a control unit is connected to the electrodes.

Wherein, according to the claimed invention, the reactor also comprises a second discharge chamber filled with metal granules (balls) and connected to the first chamber by a connecting pipe for feeding the coagulated suspension from the first chamber to the second chamber. Wherein one chamber is filled with iron granules, and the other chamber is filled with aluminum granules. Wherein the inlet pipe for supplying liquid waste is connected to the first chamber, and the outlet pipe for removing the coagulated suspension is connected to the second chamber.

Wherein, according to the claimed invention, the size of granules (balls) is correlated with the internal diameter of discharge chambers in the following manner:

$$0 , 001 D \leq d \leq 0 , 15 D$$

where, d is the diameter of balls (granules), mm, D is the inner diameter of the chamber, mm.

Wherein, according to the claimed invention, the reactor additionally contains a source of the ozone-air mixture and a mixer connected one after another with the inlet pipe for supplying liquid waste to the reactor.

The task is also solved by creating a method of using the plasma electroerosion reactor for treating liquid waste, according to which liquid waste is continuously fed under pressure into the reactor through the inlet pipe. The source of rectangular pulses with a voltage amplitude having values in the range of 300 to 800 V depending on the type of pollutants is turned on with the control unit to supply rectangular pulses to the discharge electrodes and to create a volumetric discharge between loaded granules (balls) and volumetric microplasma, respectively, that ionizes the liquid forming nanoparticles of the metal from which granules are made. At the same time, the process of coagulation and separation of organic and/or inorganic pollutants, in particular, heavy metals, and/or radioactive isotopes from the solution takes place in the reactor with the help of the coagulant, which is the hydroxide of the metal from which the granules are made and which is formed during the plasma chemical reaction, that results in the transition of pollutants from a soluble state into an insoluble state. Then the suspension formed during the purification process is removed from the reactor through the outlet pipe. Further, this suspension is fed, for example, to a membrane filter to be separated into a solid fraction and water.

Wherein, according to the claimed invention, liquid waste is fed through the inlet pipe under pressure into the first discharge chamber filled with metal granules made of one type of material—iron or aluminum; after the end of the coagulation process in the first chamber, the suspension is fed through the connecting pipe to the second discharge chamber filled with metal granules of another type of material—aluminum or iron; after the end of the coagulation process in the second chamber, the resulting suspension is fed to the outlet pipe.

Wherein, according to the claimed invention, liquid waste is pre-mixed with a sorbent.

Wherein, according to the claimed invention, liquid waste is pre-saturated with an ozone-air mixture in the mixer connected to the inlet pipe of the reactor.

Wherein, according to the claimed invention, the rectangular pulses applied to the electrodes are bipolar, i.e. each subsequent pulse changes polarity to the opposite one, and have a frequency of 50-200 Hz.

The technical result of the claimed invention is as follows:
the process is implemented using two discharge chambers, one of which is filled with granules (balls) made of iron and the other is filled with granules (balls) made of aluminum, the contaminated liquid is coagulated sequentially with hydroxides of iron and aluminum, as well as bipolar rectangular pulses with a voltage amplitude of more than 300-800 V and a frequency of 50-200 Hz are supplied to the electrodes of the device allowing to intensify significantly the coagulation process and the degree of liquid waste treatment, respectively;
the declared dependence between the value of the internal diameter of the discharge chamber and the diameter of loaded balls (granules) allows to increase the efficiency of the device and the degree of liquid waste treatment, respectively. When balls are of a relatively small size, the energy of the discharge created by the reactor electrodes is divided into a large number of micro-discharges resulting in the low power of each micro-discharge, which is not enough to obtain nanoparticles. Instead, ultraviolet radiation is generated and the liquid is partially heated. When balls are of a large size, the number of micro-discharges is smaller, the power of each discharge is high and agglomeration (sticking) processes take place between balls. At the same time, the number of formed nanoparticles is insufficient for the effective implementation of the coagulation process.
the declared electrical parameters of the pulses are also related to the generation of optimal energy in one micro-discharge for the effective implementation of the process. Under conditions of low pulse power, the discharge is unstable and the of nanoparticles are hardly generated. Under conditions of high pulse power, balls melt and the discharge acquires the characteristics of arc welding and the nanoparticles are hardly generated;
pre-saturation of the output contaminated liquid with an ozone-air mixture before feeding it to the first discharge chamber allows to obtain iron (III) hydroxide, which has significantly stronger coagulation properties than iron (II) hydroxide formed in discharge chambers during the operation of the device. Iron (III) hydroxide allows to remove organic impurities, heavy metals, and partially radioactive elements with high intensity and purification degree;
preliminary mixing of liquid waste with sorbents allows to increase the degree of liquid waste purification from radioactive isotopes when using the claimed device.

The proposed invention is illustrated by a figure where the elements have the following reference numbers: inlet pipe for supplying liquid waste (1), reactor body (2), electrodes (3); first discharge chamber (4), metal granules of the first discharge chamber (5), dielectric grid (6), connecting pipe (7), second discharge chamber (8), metal granules of the second discharge chamber (9), outlet pipe for removing the coagulated suspension (10), source of rectangular pulses with a control unit (11), source of ozone-air mixture (12) and mixer (13).

The proposed invention is illustrated by the following example of use. Liquid waste generated during the operation of NPP nuclear reactors is used for treatment. The liquid waste contains heavy metals such as cadmium, chromium, copper, zinc, tin, nickel, lead, radioactive elements such as cesium, strontium, americium, cobalt, as well as organic compounds in the concentrations given in Table. 2. Specified waste is pre-mixed with a sorbent. Liquid waste is fed under pressure to the mixer (13) to which an ozone-air mixture is fed from the source (12) simultaneously. The liquid is fed from the mixer (13) through the inlet pipe (1) of the reactor (2) to the first discharge chamber (4) filled with iron granules (balls) (5) forming a pseudo-liquefied mixture. With the help of the control unit, the source of rectangular pulses (11) is turned on. The resulting suspension is fed through the dielectric grid (6) in the upper part of the first chamber through the connecting pipe (7) into the second discharge chamber (8) with aluminum granules (9) where the coagulation process similar to the process in the first discharge chamber (4) takes place. The resulting suspension is fed outside the reactor (2) through the dielectric grid (6) in the upper part of the second discharge chamber (8) through the outlet pipe (10). Then press filters or other equipment are used to separate the coagulated sediment from the purified liquid.

As illustrated by the example of treating a model liquid, Tables 1 and 2 show the optimal operating modes of the claimed device as well as the concentrations of pollutants before and after passing through the claimed device.

TABLE 1

| | | Inner | | | |
|---|---|---|---|---|---|
| | | diameter of | Voltage | | |
| | Diameter of | discharge | ampli- | Fre- | Amount |
| | granules | chambers | tude | quency | of O₃, |
| Parameters | d, mm | D, mm | V | Hz | g/L |
| Experiment 1 | 2 | 40 | 600 | 50 | 4 |
| Experiment 2 | 3 | 40 | 650 | 100 | 5 |
| Experiment 3 | 4 | 40 | 700 | 150 | 6 |
| Experiment 4 | 5 | 40 | 750 | 170 | 7 |
| Experiment 5 | 6 | 40 | 800 | 200 | 8 |

TABLE 2

| Liquid waste | Initial concentration | Final concentration, mg/L/Experiment | | | | |
|---|---|---|---|---|---|---|
| component | mg/L | 1 | 2 | 3 | 4 | 5 |
| Mn | 7.4 | 7.2 | 6.8 | 6.1 | 5.9 | 5.65 |
| Fe | 17.3 | 17.1 | 14.2 | 12.8 | 8.8 | 6.75 |
| Cu | 0.62 | 0.6 | 0.58 | 0.58 | 0.41 | 0.37 |
| | Initial radioactivity | | | | | |
| | Bq/kg | Final radioactivity, Bq/kg/Experiment | | | | |
| ¹³⁷Cs | 75.31 | 72.56 | 54.68 | 21.89 | 9.25 | 0 |
| ⁹⁰Sr | 195.34 | 182.24 | 102.36 | 33 | 7 | 0 |
| ⁶⁰Co | 0.32 | 0.31 | 0.30 | 0.27 | 0.26 | 0.25 |
| organic | 450 | 430 | 395 | 345 | 310 | 275 |
| compounds | | | | | | |

1. A plasma electroerosion reactor for treating liquid waste, comprising:
an inlet pipe for supplying liquid waste, located in the lower part of the reactor;
a discharge chamber of a cylindrical or another curvilinear shape made of dielectric material and filled with metal granules (balls), wherein, in the lower and upper parts of the chamber, there is a dielectric grid;
an outlet pipe for removing the coagulated suspension in the upper part of the reactor; and
metal electrodes on the inner surface of the reactor, wherein a source of rectangular pulses with a control unit is connected to the electrodes,
wherein the reactor further comprises a second discharge chamber filled with metal granules (balls) and connected to the first chamber by a connecting pipe for feeding the coagulated suspension from the first chamber to the second chamber,
wherein one chamber is filled with iron granules, and the other chamber is filled with aluminum granules, and
wherein the inlet pipe for supplying liquid waste is connected to the first chamber and the outlet pipe for removing the coagulated suspension is connected to the second chamber.

2. The plasma electroerosion reactor for treating liquid waste according to claim 1, wherein the size of granules (balls) is correlated with the internal diameter of discharge chambers in the following manner:
$$0 , 001 D \leq d \leq 0 , 15 D$$
where, d is the diameter of balls (granules), mm, D is the inner diameter of the chamber, mm.

3. The plasma electroerosion reactor for treating liquid waste according to claim 1, wherein the reactor additionally contains a source of the ozone-air mixture and a mixer connected one after another with the inlet pipe for supplying liquid waste to the reactor.

4. A method of using the plasma electroerosion reactor for treating liquid waste according to claim 1, according to which liquid waste is continuously fed under pressure into the reactor through the inlet pipe, the source of rectangular pulses with a voltage amplitude having values in the range of 300 to 800 V is turned on with the control unit to supply rectangular pulses to the discharge electrodes and to create a volumetric discharge between loaded granules (balls) and volumetric microplasma, respectively, that ionizes the liquid forming nanoparticles of the metal from which granules are made, wherein the process of coagulation and separation of organic and/or inorganic pollutants, in particular, heavy metals, and/or radioactive isotopes from the solution takes place in the reactor with the help of the coagulant, which is the hydroxide of the metal from which the granules are made and which is formed during the plasma chemical reaction, that results in the transition of pollutants from a soluble state into an insoluble state, then the suspension formed during the purification process is removed from the reactor through the outlet pipe, wherein the liquid waste is fed through the inlet pipe under pressure into the first discharge chamber filled with metal granules made of one type of material—iron or aluminum, after the end of the coagulation process in the first chamber, the suspension is fed through the connecting pipe to the second discharge chamber filled with metal granules of another type of material—aluminum or iron, after the end of the coagulation process in the second chamber, the resulting suspension is fed to the outlet pipe.

5. The method of using the plasma electroerosion reactor for treating liquid waste according to claim 4, characterized in that before the plasma electroerosion reactor is supplied to the inlet pipe the liquid waste is pre-mixed with a sorbent.

6. The method of using the plasma electroerosion reactor for treating liquid waste according to claim 4, wherein the liquid waste is additionally saturated with an ozone-air mixture in the mixer connected to the inlet pipe of the reactor.

7. The method of using the plasma electroerosion reactor for treating liquid waste according to claim 4, wherein the rectangular pulses applied to the electrodes are bipolar, i.e. each subsequent pulse changes polarity to the opposite one, and have a frequency of 50-200 Hz.
